(19) United States
(12) Patent Application Publication
(10) Pub. No.: US 2008/0313311 A1
(43) Pub. Date: Dec. 18, 2008

(54) Information Service for Subscribers Who are Not Registered in Enum

(75) Inventors: Felix Flemisch, Munchen (DE); Jurgen Heiles, Munchen (DE); Jorg Ottensmeyer, Hohenkirchen (DE); Helmut Schink, Munchen (DE)

Correspondence Address: BELL, BOYD & LLOYD, LLP, P.O. BOX 1135, CHICAGO, IL, 60690, US

(73) Assignee: Nokia Siemens Networks GmbH & Co. KG, Muenchen (DE)

(21) Appl. No.: 11/997,717

(22) PCT Filed: Jul. 24, 2006
(86) PCT No.: PCT/EP06/64593

§ 371 Date: Aug. 26, 2008

(30) Foreign Application Priority Data
Aug. 1, 2005 (EP) 05016706.3

(51) Int. Cl. G06F 15/16

(52) U.S. Cl. 709/220

(57) ABSTRACT

At the ENUM introductory phase, a problem occurs when a called subscriber is not registered in the ENUM directory listing. In such a situation, a calling subscriber can initiate the ENUM request but it receives an error message only since no inscription exists in the ENUM registration with respect to said FQDN. The aim of said invention is to shorten said introductory phase. According to the invention, the subscriber called according to the ENUM request, is thereby informed about possibilities offered by the ENUM system in the case when the DNS registration is not available.

### CLAIM FOR PRIORITY

This application is a national stage of PCT/EP2006/064593, filed Jul. 24, 2006, which claims the benefit of priority to EP05016706.3, filed Aug. 1, 2005, the contents of which are hereby incorporated by reference.

### TECHNICAL FIELD OF THE INVENTION

The invention is related to an information service for subscribers not registers in ENUM.

### BACKGROUND OF THE INVENTION

In convergent networks, that is to say in telecommunication networks in which-the traditional telecommunication services are offered on an infrastructure which is based on Internet protocols, the addressing of the subscriber represents a problem since different number areas (in the Internet IP addresses and domain names, in telephony the so-called E.164 numbers) are used. This problem is intended to be solved in accordance with the decision by the ITU and the IETF, that is to say the responsible standardization committees, by the ENUM protocol and service. In this case, the telephone number of a terminal according to E.164 is converted to a domain name, a so-called Fully Qualified Domain Name (FQDN), and this domain name is then sent to a DNS (Domain Name Server) in order to obtain ENUM entries relating to the associated addressing options (for example via E-mail, SIP telephone, etc).

One problem that arises in this context occurs when there is no ENUM entry for the called subscriber. This situation will be very frequent during the introduction phase, since the regulation authorities have decided that the subscriber must actively note this entry (“user opt in”) . It can therefore be expected that it will take many years before the majority of subscribers have decided to accept an ENUM service. During this phase, although the calling subscriber can start an ENUM request, he will, receive only an error message since there is no ENUM entry relating to this Fully Qualified Domain Name (FQDN).

The problem is therefore to make the starting and transitional phase as short as possible.

So far, no methods are known. The “opt in” procedure has been specified so far by the regulating authorities.

### SUMMARY OF THE INVENTION

In one embodiment of the invention, there is a method for communication in communication networks, including submitting a request via a terminal of an ENUM subscriber for an ENUM entry to a DNS; determining the ENUM entry by the DNS using the a FQDN stated in the request; and automatically sending the subscriber associated with the FQDN information relating to the ENUM service if the stated attempt fails and/or there are additional further circumstances relating to the FQDN.

In one aspect, the information is provided via an information computer which is informed by the DNS of the failed ENUM attempts.

In another aspect, additional further circumstances likewise relate to failed ENUM attempts relating to the FQDN.

In another embodiment, a DNS which receives a request for an ENUM entry, attempts to determine the ENUM entry using the FQDN stated in the request, wherein if the attempt fails or there are additional further circumstances relating to this FQDN, the DNS automatically sends information relating to the ENUM service to the subscriber associated with that FQDN.

In still another embodiment, a computer readable medium having executable code stored on the medium, the code when executed by a computer, includes receiving information from a DNS when the DNS has unsuccessfully attempted to determine an ENUM entry relating to an FQDN; and immediately informing the subscriber associated with that FQDN about the ENUM service based on the information, or if there are additional further circumstances relating to the FQDN.

### BRIEF DESCRIPTION OF THE DRAWINGS

The invention will be explained in more detail in the following text with reference to the drawing, in which:

FIG. 1 shows an information service in accordance with the invention.

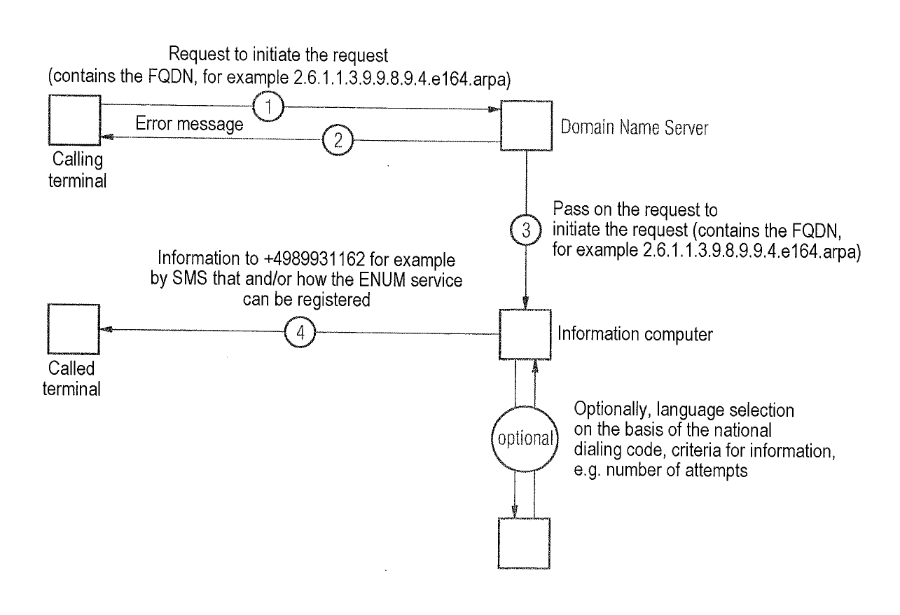

### DETAILED DESCRIPTION OF THE INVENTION

The FQDN which is sent (1) in an ENUM request from the terminal of a calling subscriber or a gateway associated with that subscriber to the DNS includes the entire telephone number of the called subscriber. If there is no DNS entry, that is if the called subscriber has not yet been registered, the DNS produces an error message (2). This error message is sent to the terminal of the called subscriber.

Furthermore, the called subscriber or the called terminal is immediately notified (4) via the ENUM service of the lack of a DNS entry, either immediately or when further circumstances or criteria occur (for example when the specific minimum number of ENUM requests have been made unsuccessfully relating to this connection). The subscriber can be informed by the DNS itself or by an information computer (as illustrated in the FIGURE) (4) which signals (3) failed ENUM requests to the DNS.

The notification can be provided, for example, by sending an SMS. The language of the message may be chosen, for example, on the basis of the national dialing code. By way of example, the message can provide information that there is an ENUM service through the use of which it is possible to register with the ENUM service. Furthermore, the message may, for example, include information for simple operation, for example a hyperlink.

The computer to which a DNS passes on failed ENUM requests for this purpose, according to one embodiment of the invention, uses the syntax to check whether the stated number can be an E.164. If yes, an SMS, for example, is sent to this number. If a plurality of communication paths are identified, an information list can also be created and/or extended in order to notify the subscriber of the various routes. Depending on satisfaction of the criteria for syntax analysis, the subscriber is therefore informed, and one or more communication forms may be used for this purpose.

1. A method for communication in communication networks, comprising:
submitting a request via a terminal of an ENUM subscriber for an ENUM entry to a DNS;
determining the ENUM entry by the DNS using the a FQDN stated in the request; and
automatically sending the subscriber associated with the FQDN information relating to the ENUM service if the stated attempt fails and/or there are additional further circumstances relating to the FQDN.

2. The method as claimed in claim 1,
wherein the information is provided via an information computer which is informed by the DNS of the failed ENUM attempts.

3. The method as claimed in claim 1,
wherein additional further circumstances likewise relate to failed ENUM attempts relating to the FQDN.

4. A DNS which receives a request for an ENUM entry, attempts to determine the ENUM entry using the FQDN stated in the request,
wherein
if the attempt fails or there are additional further circumstances relating to this FQDN, the DNS automatically sends information relating to the ENUM service to the subscriber associated with that FQDN.

5. A computer readable medium having executable code stored on the medium, the code when executed by a computer, comprising:
receiving information from a DNS when the DNS has unsuccessfully attempted to determine an ENUM entry relating to an FQDN; and
immediately informing the subscriber associated with that FQDN about the ENUM service based on the information, or if there are additional further circumstances relating to the FQDN.
